(19) United States
(12) Patent Application Publication
(10) Pub. No.: US 2014/0115137 A1
(43) Pub. Date: Apr. 24, 2014

(54) Enterprise Computing System with Centralized Control/Management Planes Separated from Distributed Data Plane Devices

(71) Applicant: CISCO TECHNOLOGY, INC., San Jose, CA (US)

(72) Inventor: Suresh Singh Keisam, San Jose, CA (US)

(73) Assignee: CISCO TECHNOLOGY, INC., San Jose, CA (US)

(21) Appl. No.: 13/659,172

(22) Filed: Oct. 24, 2012

(51) Int. Cl. G06F 15/173

(52) U.S. Cl. 709/223

(57) ABSTRACT

Presented herein is an enterprise computing system that uses a single logical networking device (i.e., single internal logical switch or router) to interconnect a plurality of blade server chassis. The enterprise computing system comprises a plurality of blade server chassis that include one or more leaf cards. The system also comprises one or more crossbar chassis connected to the plurality of blade server chassis, and one or more control and management servers connected to one or more of the crossbar chassis.

### TECHNICAL FIELD

The present disclosure relates to an enterprise computing system.

### BACKGROUND

An enterprise computing system is a data center architecture that integrates computing, networking and storage resources. Enterprise computing systems comprise groups of components or nodes interconnected by a network so as to form an integrated and large scale computing entity. More specifically, an enterprise computing system comprises multiple chassis, commonly referred to as rack or blade server chassis, which include server computers (rack or blade servers) that provide any of a variety of functions. The blade servers in a plurality of blade server chassis are generally interconnected by a plurality of switches. One example of an enterprise computing system is Cisco System's Unified Computing System (UCS).

### BRIEF DESCRIPTION OF THE DRAWINGS

FIG. 1 is a block diagram of an enterprise computing system in accordance with examples presented herein.

FIG. 2 is a block diagram illustrating a blade server chassis and a crossbar chassis in accordance with examples presented herein.

FIG. 3 is another block diagram of the enterprise computing system of FIG. 1.

FIG. 4 is a block diagram illustrating another enterprise computing system with multiple virtual computing domains in accordance with examples presented herein.

FIG. 5 is a block diagram illustrating further details of a multi-stage crossbar chassis based crossbar fabric interconnecting a plurality of blade server chassis in accordance with examples presented herein.

FIG. 6A is a block diagram of a blade server in accordance with examples presented herein.

FIG. 6B is a block diagram of a leaf card in accordance with examples presented herein.

FIG. 7 is a block diagram of a crossbar chassis in accordance with examples presented herein.

FIG. 8 is a block diagram of an enterprise computing system in accordance with examples presented herein.

FIG. 9 is a block diagram of a centralized control and management plane for an enterprise computing system in accordance with examples presented herein.

FIG. 10 is a block diagram showing software components of an enterprise computing system in accordance with examples presented herein.

FIG. 11 is a block diagram showing software components of an enterprise computing system in accordance with examples presented herein.

FIG. 12 is a block diagram illustrating the flow of a packet from a first blade server to a second blade server or an external networking device in accordance with examples presented herein.

FIG. 13 is block diagram of another enterprise computing system using multiple Ethernet-out-of-band management switches in accordance with examples presented herein.

FIGS. 14-21 are flowcharts of methods in accordance with examples presented herein.

### DESCRIPTION OF EXAMPLE EMBODIMENTS

### Overview

Presented herein is an enterprise computing system that uses a single logical networking device (i.e., single internal logical switch or router) to interconnect a plurality of blade server chassis. The enterprise computing system comprises a plurality of blade server chassis that include one or more leaf cards. The system also comprises one or more crossbar chassis connected to the plurality of blade server chassis, and one or more control and management servers connected to one or more of the crossbar chassis.

In accordance with examples presented herein, the enterprise computing system operates as a single logical computing entity having centralized control and management planes and a distributed data plane. The one or more crossbar chassis provide the functionality of multiple crossbar-cards in a traditional single device (modular) switch or router. The one or more leaf cards of a blade server chassis operate as multiple distributed forwarding line-cards of a traditional single device switch or router. The one or more control and management servers provide centralized control and management planes and provide the functionality of supervisors of a traditional single device switch or router.

### Example Embodiments

Conventional enterprise computing systems comprise a plurality of independent blade server chassis that each house blade servers and switch cards. These switch cards are full Layer-2 (L2)/Layer-3 (L3) switches having their own control and data planes that are coupled together in a single blade server chassis. Additionally, the blade server chassis in such conventional enterprise computing systems are interconnected by a plurality of independent L2/L3 switches (each also with its own coupled control and data plane). In such conventional enterprise computing systems, all of the blade server chassis and the switches cooperate with one another to form a centrally managed system, but each switch and blade server chassis still operates as an independent and separate entity. In other words, the switch cards in the blades server chassis and the switch cards in the external switches (i.e., the switches interconnecting the blade server chassis) are each comprised of independent data and control planes, even though centralized management may be provided.

In such conventional enterprise computing systems, the switch card on a blade server chassis has its own control plane protocols which populate its local forwarding tables. As such, when a packet is received from a blade server by a switch card, the switch card will perform an independent L2/L3 forwarding lookup and forward the packet to one or more of the external switches. These external switches each also have its own control plane protocols which populate the local forwarding tables. As such, the external switches will each perform another independent L2/L3 forwarding lookup and will send the packet to one or more switch cards of one or more destination blade server chassis. The conventional enterprise computing systems comprise multiple independent full L2/L3 switches that have control and data planes residing on the same “box” (same physical device). The use of these multiple independent control and data planes limit the scalability of the conventional enterprise computing systems and add management overhead.

In other conventional enterprise computing systems, the blade server chassis are connected to one or more external fabric-interconnect switches, where each fabric-interconnect switch has its own centralized control and data planes (i.e., perform centralized L2/L3 forwarding lookups). In other words, these conventional systems use centralized control, data and management planes in the same physical device that interconnects the blade server chassis. This arrangement limits the scalability of the control, data, and management planes.

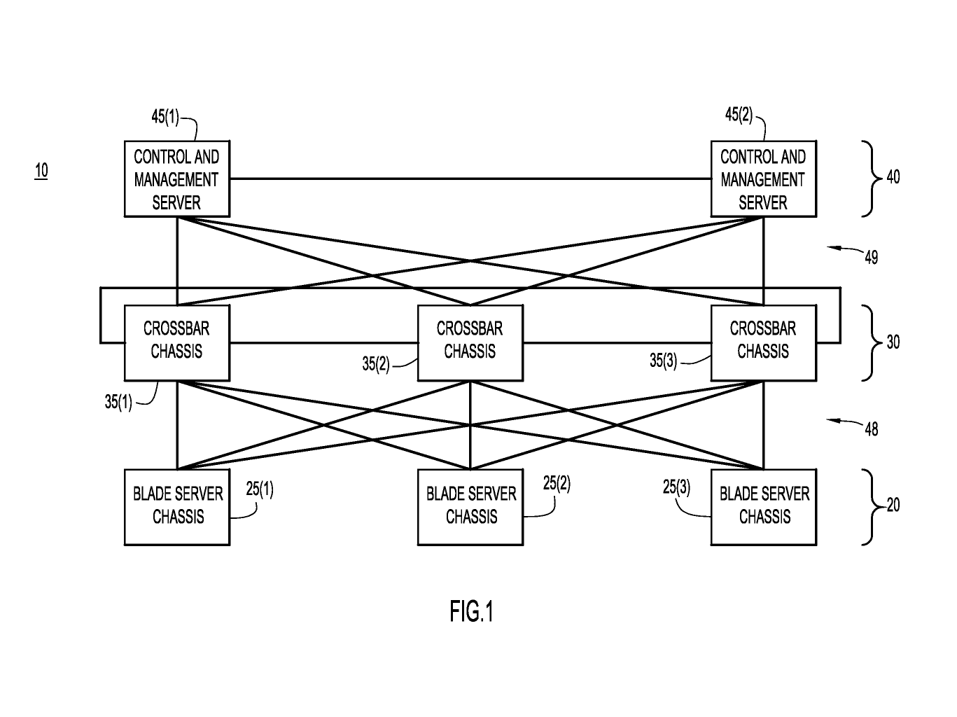

FIG. 1 is a block diagram of an enterprise computing system 10 in accordance with examples presented herein. Enterprise computing system 10 comprises an application server set 20, a crossbar fabric set 30, and a control and management server set 40. The application server set 20 comprises three blade server chassis 25(1), 25(2), and 25(3), crossbar fabric set 30 comprises three crossbar chassis 35(1), 35(2), and 35(3), and control and management server set 40 comprises two control and management servers 45(1) and 45(2). As described further below, the three crossbar chassis 35(1), 35(2), 35(3) and leaf cards (not shown in FIG. 1) of blade server chassis 25(1), 25(2) and 25(3) collectively provide a distributed data plane 48 for enterprise computing system 10. Also as described further below, the two control/management servers 45(1) and 45(2) provide a centralized control and management plane 49 for the enterprise computing system 10 that is physically separate from the distributed data plane devices. As such, enterprise computing system 10 operates as a logical single compute entity having centralized control and management planes, and a separate distributed data plane.

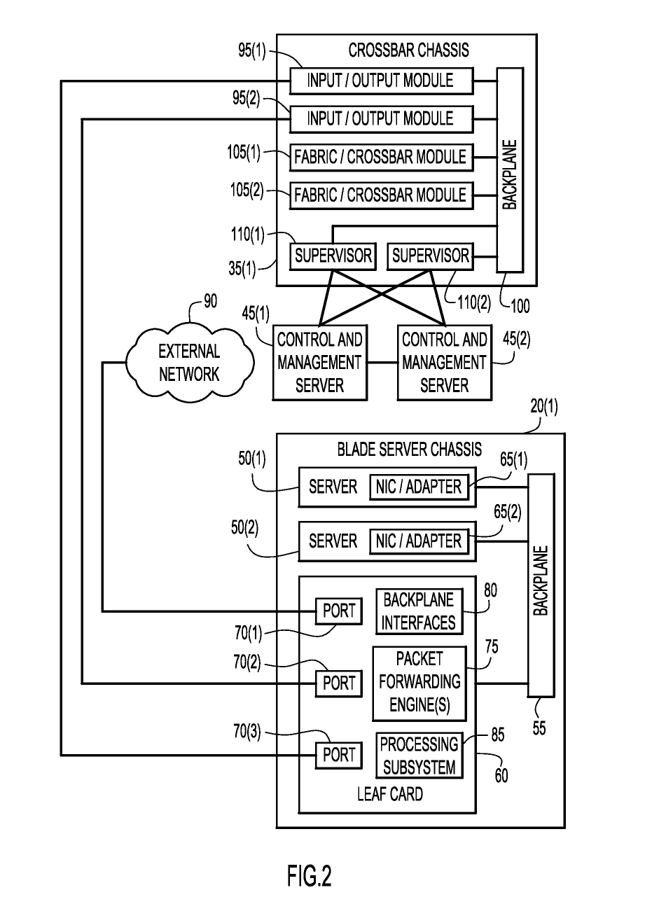

FIG. 2 is a block diagram illustrating further details of blade server chassis 25(1) and crossbar chassis 35(1). For ease of illustration, the other blade server chassis 25(2) and 25(3), as well as the crossbar chassis 35(2) and 35(3) have been omitted from FIG. 2.

Blade server chassis 25(1) comprises two blade servers 50(1) and 50(2), a backplane 55, and a leaf card 60. Blade servers 50(1) and 50(2) comprise an internal network interface device 65(1) and 65(2), respectively. The network interface devices 65(1) and 65(2) are sometimes referred to as network interface cards (NICs) or network adapters and are configured to communicate with backplane 55. Leaf card 60 comprises three ports 70(1), 70(2), and 70(3), a packet forwarding engine 75, backplane interface(s) 80, and a processing subsystem 85. Processing subsystem 85 may include, for example, processors, memories, etc.

Leaf card 60 is, in general, configured to perform L2 and L3 forwarding lookups as part of a distributed data plane of a single logical networking device (e.g., internal logical switch or router) that is shared between a plurality of blade servers. The other functions provided by leaf card 60 include, but are not limited to, discovery operation for all components in a blade server chassis (e.g., blade servers, blade server chassis, leaf card, fan, power supplies, NICs, baseboard management controller (BMC), etc.), chassis bootstrapping and management, chassis health monitoring, fan speed control, power supply operations, and high-availability (if more than one leaf card is present).

The packet forwarding engine(s) 75 provide, among other functions, L2 and L3 packet forwarding and lookup functions. The packet forwarding engine(s) 75 may be implemented in an application specific integrated circuit (ASIC), in digital logic gates, in system-on-chip network processors, in system-on-chip multi-core general purpose processors or in programmable logic, such as in one or more field programmable gate arrays (FPGAs). Port 70(1) of lead card 60, which is configured as an external network port, is connected to an external network 90. External network 90 may comprise, for example, a local area network (LAN), wide area network (WAN), etc.

Ports 70(2) and 70(3), which are configured as internal network ports, are connected to crossbar chassis 35(1). In certain examples, the ports 70(2) and 70(3) may each connect to a blade server 50(1) or 50(2) via a corresponding internal network interface 65(1) or 65(2) and packets to/from those servers are forwarded via the corresponding port.

Crossbar chassis 35(1) comprises input/output modules 95(1) and 95(2) connected to a backplane 100. The ports of input/output modules 95(1) and 95(2) are connected to ports 70(3) and 70(2), respectively, of blade server chassis 20(1). In operation, the ports of these input/output modules 95(1) and 95(2) would also be connected to other blade server chassis, or other crossbar chassis, within the enterprise computing system 10.

Crossbar chassis 35(1) also comprises two fabric/crossbar modules 105(1) and 105(2) and two supervisor cards 110(1) and 110(2). In operation, a packet (after L2 or L3 lookup at a leaf card) is received at a port of one of the input/output modules 95(1) or 95(2) from blade servers 50(1) or 50(2). As described further below, the received packet has a special unified-compute header that is used to determine the correct output port(s) of the destination input/output card(s) and the correct fabric/crossbar module(s). At the crossbar chassis 35(1), a fabric header is appended to the packet by the input/output cards and the packet is forwarded, via the fabric/crossbar modules 105(1) and 105(2), to the same or different input/output module. The fabric/crossbar modules 105(1) and 105(2) use the fabric header to select the correct crossbar port(s) which are connected to destination input/output card(s). The input/output modules 95(1) and 95(2), along with fabric/crossbar modules 105(1) and 105(2), perform this fabric-header based forwarding under the control of the supervisor cards 110(1) and 110(2) that receive control information from the control and management servers 45(1) and 45(2). Unlike conventional arrangements, no End-to-End L2/L3 header forwarding lookups are performed at the fabric/crossbar chassis. The supervisor cards 110(1) and 110(2) provide, among other functions, discovery functionality for all components in a crossbar chassis (e.g., input/output cards, crossbar cards, supervisor cards, fan, power supplies, ports, etc.), crossbar management, virtual-output-queues management for input/output cards, Unified-Compute header lookup table management, chassis bootstrapping and management, chassis health monitoring, fan speed control, power supply operations, and high-availability (if more than one supervisor cards is present).

It is to be appreciated that FIG. 2 is merely one example and that the blade server chassis 25(1) and crossbar chassis 35(1) may have other arrangements. It is also to be appreciated that the blade serve chassis 25(2) and 25(3) and the crossbar chassis 35(2) and 35(3) may have the same or different arrangement as described above with reference to blade server chassis 20(1) and crossbar chassis 35(1), respectively.

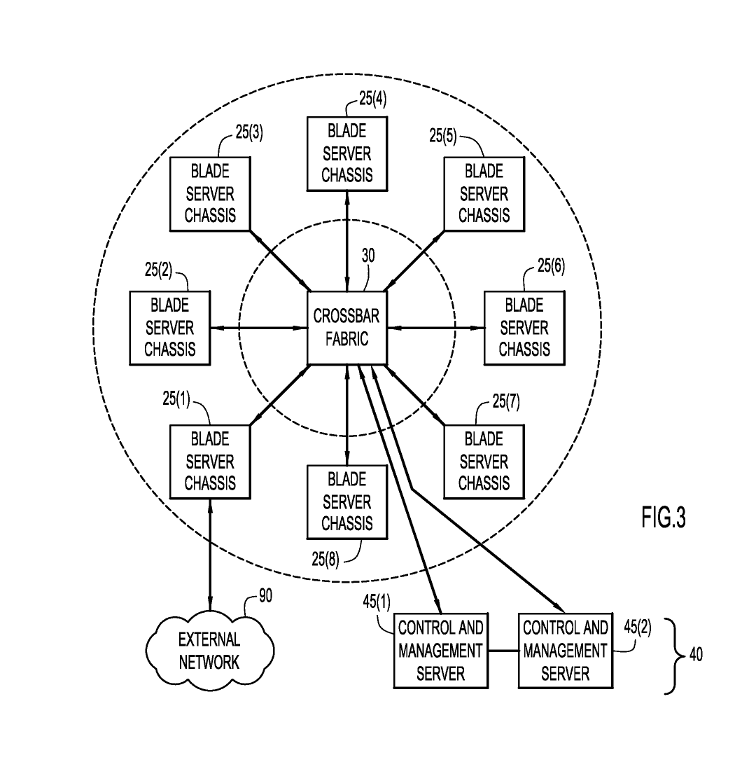

FIG. 3 is another block diagram illustrating the enterprise computing system 10 of FIG. 1. In this example, the application server set 20 comprises eight (8) blade server chassis 25(1)-25(8) each having one or more blade servers therein. FIG. 3 illustrates the enterprise computing system 10 in a hub-and-spokes configuration where the crossbar fabric 30 (comprising one or more crossbar chassis) is the crossbar “hub” of the system. In other words, the crossbar fabric 30 provides the crossbar functionality of a distributed data plane as a single logical networking device (switch or router), where one or more leaf cards of the system perform L2/L3 forwarding lookups within the system. The blade server chassis 25(1)-25(8) are the “spokes” of the enterprise computing system 10 and communicate with one another via the crossbar fabric 30. The blade server chassis 25(1)-25(8) and the crossbar functionality of the distributed data plane are controlled by centralized control and management planes provided by control and management servers 45(1) and 45(2).

In this example, a single blade server chassis 25(1) is configured to communicate with the external network 90. As such, blade server chassis 25(1) operates as the gateway through which the blade servers in the other blade server chassis 25(2)-25(8) communicate with devices on the external network 90.

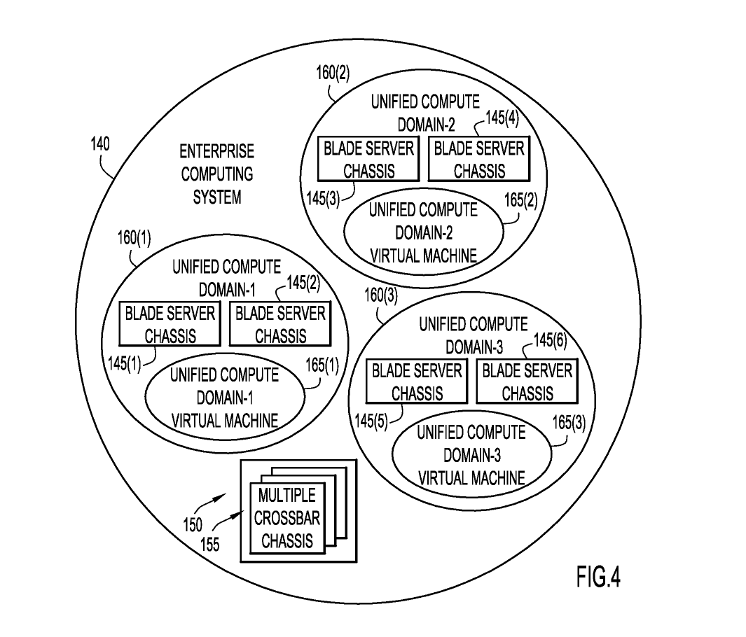

FIG. 4 is a block diagram illustrating an enterprise computing system 140 in accordance with examples presented herein. In this example, the enterprise computing system 140 comprises a plurality of blade server chassis 145(1), 145(2), 145(3), 145(4), 145(5), and 145(6) interconnected by a crossbar fabric 150 formed from multiple crossbar chassis 155. In this example, the blade server chassis 145(1), 145(2), 145(3), 145(4), 145(5), and 145(6) are logically separated into different virtual unified-compute domains. More specifically, blade server chassis 145(1) and 145(2) are part of a first virtual unified-compute domain 160(1), blade server chassis 145(3) and 145(4) are part of a second virtual unified-compute domain 160(2), and blade server chassis 145(5) and 145(6) are part of a third virtual unified-compute domain 160(3). The virtual unified-compute domains 160(1), 160(2), and 160(3) comprise unified-compute domain virtual machines 165(1), 165(2), and 165(3), respectively, which act as the control and management plane for their respective unified-compute domain. When one or more control and management plane servers boot up, two unified-compute-master (UCM) virtual machines will be started by a virtual machine controller. Role-negotiation will result in, for example, one virtual machine becoming an active UCM virtual machine and the other a standby virtual machine. Similarly, based on a selected configuration, at least one or more unified-compute domain virtual machines will be started by software running in the active UCM virtual machine, where each unified-compute domain virtual machine runs its own control protocols (e.g., L2, L3, and storage protocols). As one or more crossbar chassis are discovered and registered by the management plane software of the active UCM virtual machine, they are used as shared resources between all the distributed data planes of the one or more unified-compute domains. When one or more blade server chassis are discovered and registered by the active UCM virtual machine, based on a selected configuration, each one is assigned to a particular unified-compute domain. The management plane software of a corresponding unified-compute-domain virtual-machine discovers and registers all the components of one or more blade server chassis that belongs to its domain. The control plane software of the corresponding unified-compute-domain virtual-machine also programs all the forwarding lookup tables of all leaf cards to form a single internal domain-specific logical networking device, which provides a distributed data plane for the particular domain. External devices belonging to external networks see multiple unified-compute domains. Enterprise customers and service providers (e.g., cloud service providers, web content providers, etc.) can use the multiple domains to provide multi-tenancy features, where the customers or departments are completely segregated and protected from one another. Each domain can have its own domain-administrators and domain-users and, in addition, master-administrators and master-users that have access to all or specific features of all domains in the system.

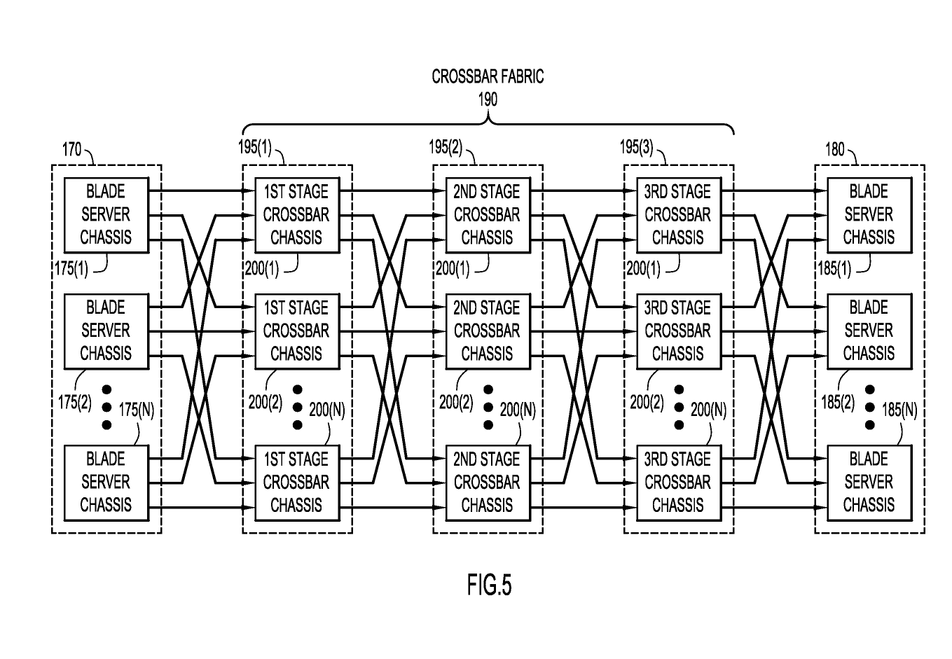

FIG. 5 is a block diagram illustrating further details of a crossbar fabric interconnecting a plurality of blade server chassis. More specifically, FIG. 5 illustrates a first set 170 of blade server chassis 175(1)-175(N) and a second set 180 of blade server chassis 185(1)-185(N). The first and second sets of blade server chassis are connected to a crossbar fabric 190 that comprises three stages 195(1), 195(2), and 195(3). Each stage 195(1), 195(2) and 195(3) comprises a plurality of crossbar chassis 200(1)-200(N).

The first set 170 of blade server chassis 175(1)-175(N) are connected to the first stage 195(1) of crossbar chassis 200(1)-200(N). The second set 180 of blade server chassis 185(1)-185(N) are connected to the third stage of crossbar chassis 210(1)-210(N). The bootup, discovery, and initialization procedures in this arrangement are similar to that of a single-stage crossbar fabric based enterprise computing system, except that the first-level crossbar chassis will be discovered and registered as one of the second-stage crossbar chassis. Subsequent crossbar chassis, which get discovered and registered via a second-stage chassis, will be initialized and programmed as first-stage/third-stage chassis. From the perspective of the blade server chassis, the three-stage crossbar fabric is viewed like a single-stage crossbar fabric. Packets are parsed and forwarded between the three-stages, based on an extended version of the same unified-compute header (includes crossbar chassis identifier, stage identifier etc.) used in a single-stage crossbar fabric. The use of a three-stage or multi-stage crossbar fabric provides scalability (increase in number of blade server chassis supported in a system), similar to the increase in the number of line cards of a multi-stage fabric based single-device or a compact form of a switch or router chassis.

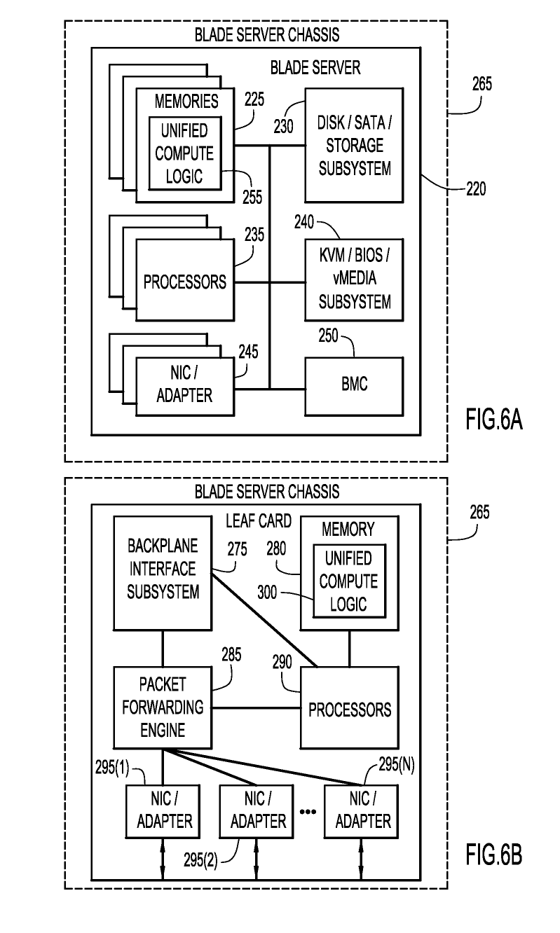

FIG. 6A is a block diagram illustrating further details of a blade server 220 in accordance with examples presented herein. Blade server 220 comprises memories 225, disks/Serial AT Attachment (SATA)/storage subsystem 230, processors 235, a Keyboard-Video-Mouse (KVM)/Basic Input/Output System (BIOS)/virtual media (vMedia) subsystem 240, network interface devices (NICs/adapters) 245, and a baseboard management controller (BMC) 250. One or more of the memories 225 comprise unified compute logic 255.

In operation, blade server 220 is a component of a blade server chassis 265 that may include additional blade servers (not shown in FIG. 6A). Network interface devices 245 are configured to communicate with a backplane of blade server chassis 265.

Memories 225 may each comprise read only memory (ROM), random access memory (RAM), magnetic disk storage media devices, optical storage media devices, flash memory devices, electrical, optical, or other physical/tangible memory storage devices. The processors 235 are, for example, multiple microprocessors or microcontrollers that execute instructions for the unified compute logic 255. Thus, in general, the memories 225 may comprise one or more tangible (non-transitory) computer readable storage media (e.g., a memory device) encoded with software comprising computer executable instructions and when the software is executed (by the processor 235) it is operable to perform the operations described herein to enable the blade server 220 to operate with other blade servers (not shown in FIG. 6A) as a logical single compute entity.

A BMC agent runs in a BMC processor (e.g., one of the processors 235). A NIC agent runs in a processor of a NIC/Adapter 245. All agents are controlled and coordinated by corresponding agent controllers running in the control and management servers. New firmware for both the BMC and NIC agents can be downloaded automatically (when default firmware is outdated) from the control and management servers. The BMC software/firmware agent provides functionality that includes, for example, Pre-Operating-System (OS) management access, blade inventory, monitoring/logging of various attributes (e.g., voltages, currents, temperatures, memory errors), LED guided diagnostics, power management, and serial-over-LAN operations. The BMC agent also supports BIOS management, KVM and vMedia. The NIC software agent initializes, program and monitor one or more physical or virtual interfaces 245 (NIC, Fiber-Channel host bust adapter (HBA), etc.). BMC agent support initial pre-OS (i.e., before OS/hypervisor is loaded on the main blade server processors 235) automatically-configured communication between the BMC agent and BMC/Intelligent Platform Management Interface (IPMI) controller in control/management servers. In one example, this is Dynamic Host Configuration Protocol (DHCP) communication. The NIC agent also provides post-OS (after OS/hypervisor is loaded) virtual/physical NICs/adapters support. The Disk/SATA/storage subsystem 230 is used to store application/system data and executable images.

FIG. 6B is a block diagram of a leaf card 270 that may be installed on blade server chassis 265 with blade server 220 of FIG. 6A. Leaf card 220 comprises a backplane interface subsystem 275, a memory 280, a packet forwarding engine 285, a processor 290, and a plurality of network interface devices (NICs/adapters) 295(1)-295(N). Memory 280 comprises unified compute logic 300.

As noted, leaf card 270 is a component of a blade server chassis 265. As such, backplane interface subsystem 275 is configured to communicate with a backplane of blade server chassis 265, and thus to communicate with the blade servers on the blade server chassis 265.

Memory 280 may comprise ROM, RAM, magnetic disk storage media devices, optical storage media devices, flash memory devices, electrical, optical, or other physical/tangible memory storage devices. The processor 290 is, for example, a microprocessor or microcontroller that executes instructions for the unified compute logic 300. Thus, in general, the memory 280 may comprise one or more tangible (non-transitory) computer readable storage media (e.g., a memory device) encoded with software comprising computer executable instructions and when the software is executed (by the processor 290) it is operable to perform the operations described herein to enable the leaf card 270 to as part of the logical single compute entity described above

Leaf card 270, in general, performs L2 and L3 forwarding lookups as part of a distributed data plane that is shared between a plurality of blade servers. The leaf card 270 may also provide other functionality as described above. The packet forwarding engine(s) 285 provide L2 and L3 packet forwarding and lookup functions as part of a distributed data plane. Various forwarding table agents running in processor 290 program the forwarding tables used by the packet forwarding engines 285. One or more of the NIC/Adapters (network interface devices) 295(1)-295(N) are used to connect directly to a plurality of crossbar chassis ports. Packet forwarding engine 285 appends a unified-compute header with appropriate information (e.g., Global Destination-Index, Global Source-Index, Hash value, control flags, etc.) to each packet that gets forwarded to the crossbar chassis. One or more NIC/Adapter 295(1)-295(N) can also be configured as external network ports which connect to an external network.

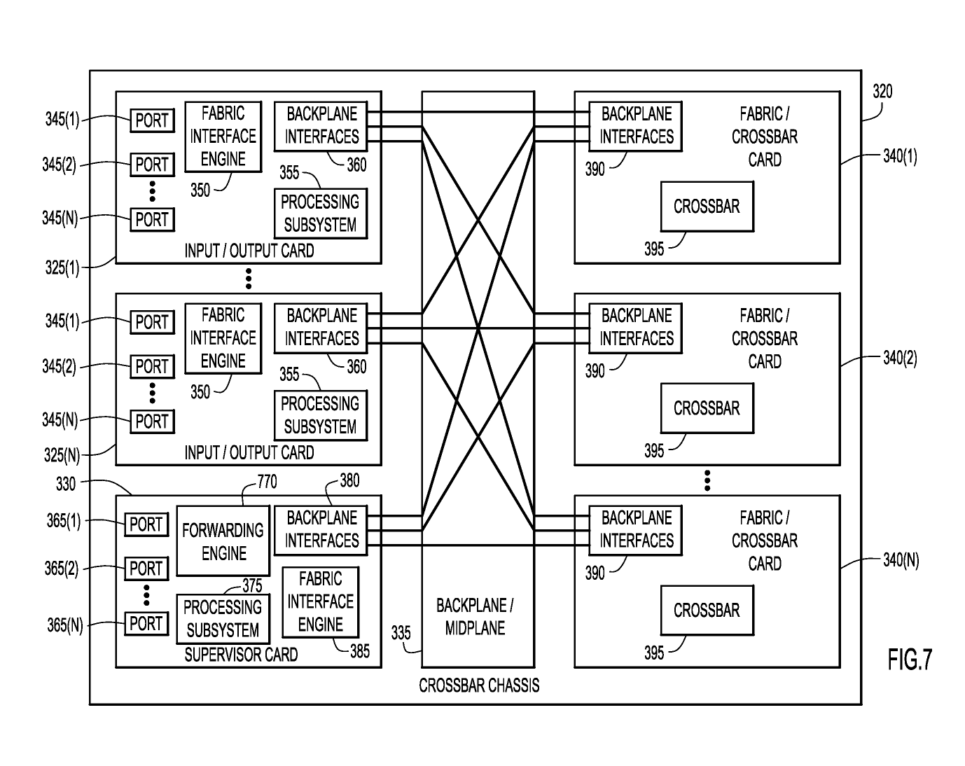

FIG. 7 is a block diagram of a crossbar chassis 320 configured to operate as part of a logical single compute entity in accordance with examples provided herein. In particular, crossbar chassis 320 is configured to be part of a data plane for the logical single compute entity.

Crossbar chassis 320 comprises a plurality of input/output cards 325(1)-325(N), a supervisor card 330, a backplane/midplane 335, and a plurality of fabric/crossbar cards 340(1)-340(N). Input/output cards 325(1)-325(N) each comprise a plurality of ports 345(1)-345(N), one or more fabric interface processors (engines) 350, a processing subsystem 355, and backplane interfaces 360. The fabric interface engines 350 provide virtual-output-queues (VOQ), credit management interfaces, and unified-compute header lookup tables for a crossbar chassis. The fabric interface engines 350 can be implemented in an ASIC, in digital logic gates, in system-on-chip network processors, in system-on-chip multi-core general purpose processors or in programmable logic, such as in one or more FPGAs.

As noted, the packets received from the leaf cards have a special unified-compute header, which is used by the fabric interface engines 350 to determine the correct output port(s) of the destination input/output card(s) and the correct fabric/crossbar module(s). The fabric interface engines 350 append a fabric header to every packet and forward those packets via the fabric/crossbar modules to the same or different input/output module. The crossbar module then uses the fabric header to select the correct crossbar port(s) which are connected to destination input/output card(s). The processing subsystems 355, which include memories and processors, run the various software agents (e.g., virtual-output-queues management agent, unified-compute-header lookup table management agent, and port management agent).

The supervisor card 330 comprises a plurality of ports 365(1)-365(N), a forwarding engine 370, a processing subsystem 375, backplane interfaces 380, and a fabric interface engine 385. The supervisor card 330 provides software running in processing subsystem 375 with discovery functionality for all components in a crossbar chassis (e.g., input/output cards, crossbar cards, supervisor cards, fan, power supplies, ports, etc.), crossbar management, virtual-output-queues management for fabric interface engine 385 and 350, unified-compute header lookup table management for fabric interface engine 385, chassis bootstrapping and management, chassis health monitoring, fan speed control, power supplies operations, and high-availability (if more than one supervisor card is present). The forwarding engine 370 and fabric interface engine 385 together provide packet forwarding functionality for internal control packets, external control packets, and in-band data packets to/from control and management plane servers. The fabric interface engine 385 is similar in functionality to fabric interface engine 350 except that it interfaces with backplane interfaces 380 for packets sent/received to/from blade server chassis. The fabric interface engine 385 also interfaces with packet forwarding engine 370 for packets sent/received to/from control and management plane servers. Both fabric interface engine 385 and forwarding engine 370 can be implemented in ASICs, in digital logic gates, in system-on-chip network processors, in system-on-chip multi-core general purpose processors or in programmable logic, such as in one or more FPGAs. The packet forwarding engine 370 has tables for providing L2, L3, and Quality-of-Service (QoS) functionality, which are programmed by software running in the supervisor.

The fabric/crossbar cards 340(1)-340(N) each comprise backplane interfaces 390 and a crossbar 395. The crossbars 395 are hardware elements (e.g., switching hardware) that forward packets through the crossbar chassis under the control of the supervisor card. More specifically, packets with an appended fabric header are forwarded from the input/output cards and received by fabric/crossbar cards 340(1)-340(N). The fabric/crossbar cards 340(1)-340(N) use the fabric header to select the correct crossbar port(s) which are connected to same or different destination input/output card(s). The crossbars in the crossbar cards are programmed by fabric manager software running in the supervisor cards using backplane interfaces 390 which include, for example, a Peripheral Connect Interface (PCI), a Peripheral Component Interconnect Express (PCIe), or a two-wire interface (I²C). The fabric/crossbar cards 340(1)-340(N) may also contain software agents running in a processing subsystem (memories, processor etc.) for coordinating the programming of the crossbars under the control of software running in the supervisor cards.

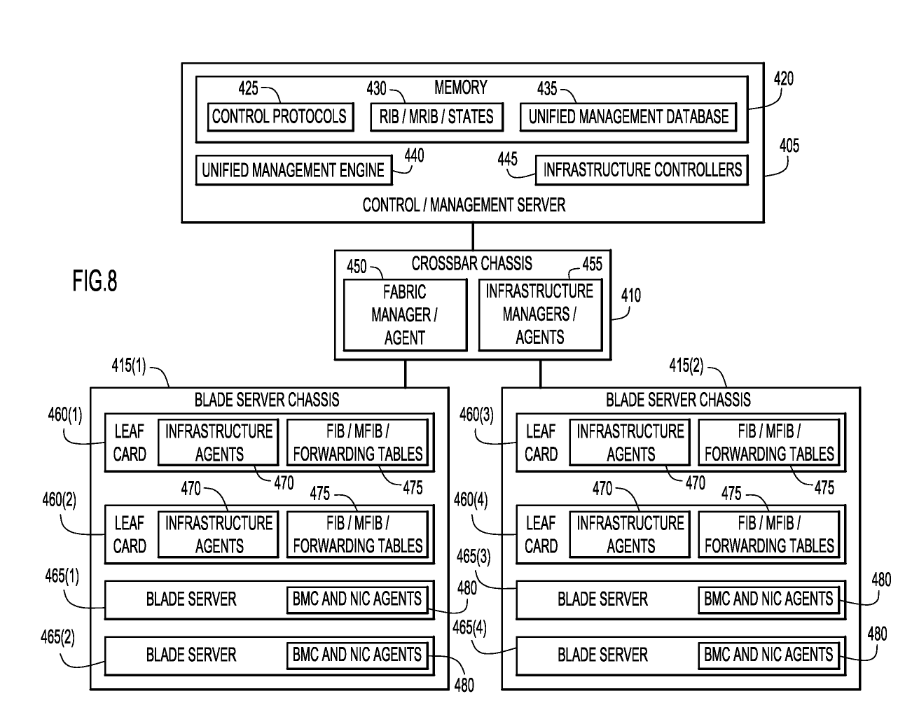

FIG. 8 is a high level block diagram illustrating hardware/software components of an enterprise computing system 400 configured to operate as a logical single compute entity having a single logical networking device. In this example, enterprise computing system 400 comprises a control/management server 405, a crossbar chassis 410, and two blade server chassis 415(1) and 415(2). The main software components of the control and management server 405 comprises control protocols 425, Routing Information Base (RIB)/Multicast Routing Information Base (MRIB)/states 430, a unified management database 435, a unified management engine 440 and infrastructure controllers 445. These software components are in a memory 420.

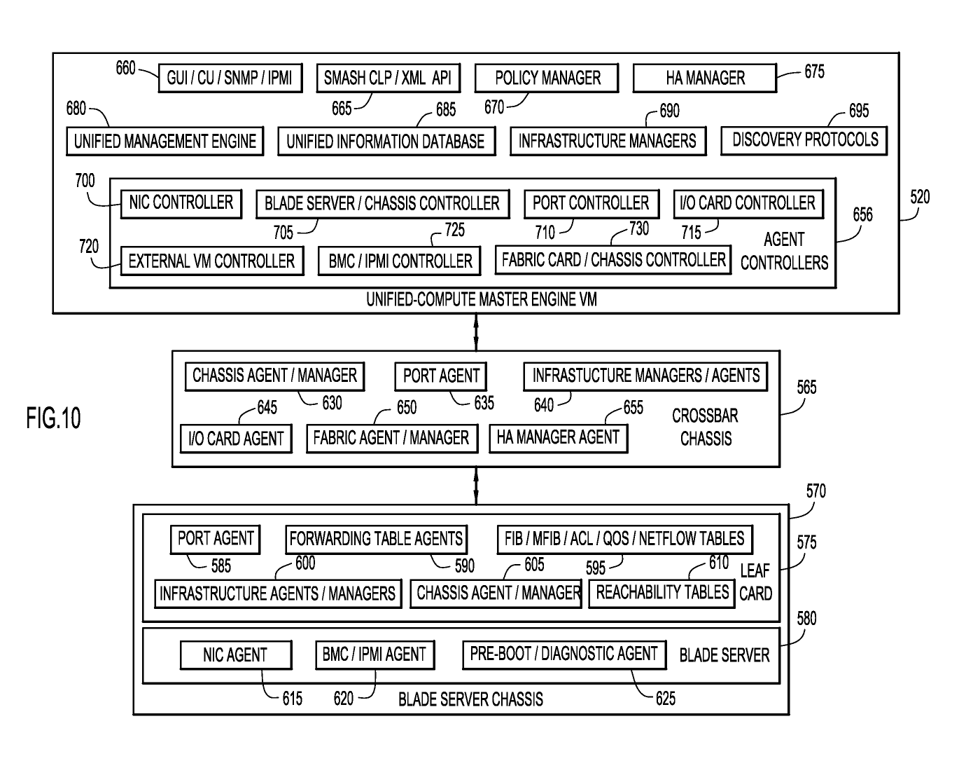

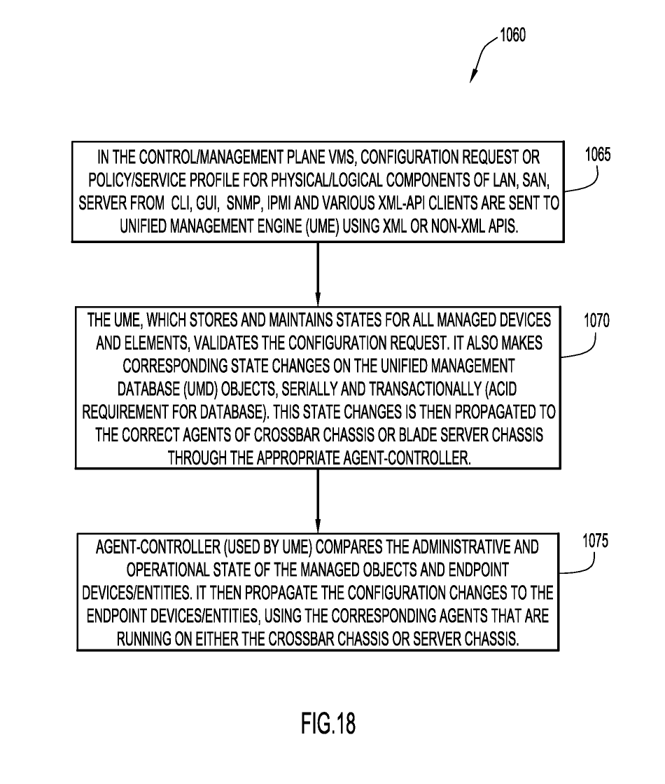

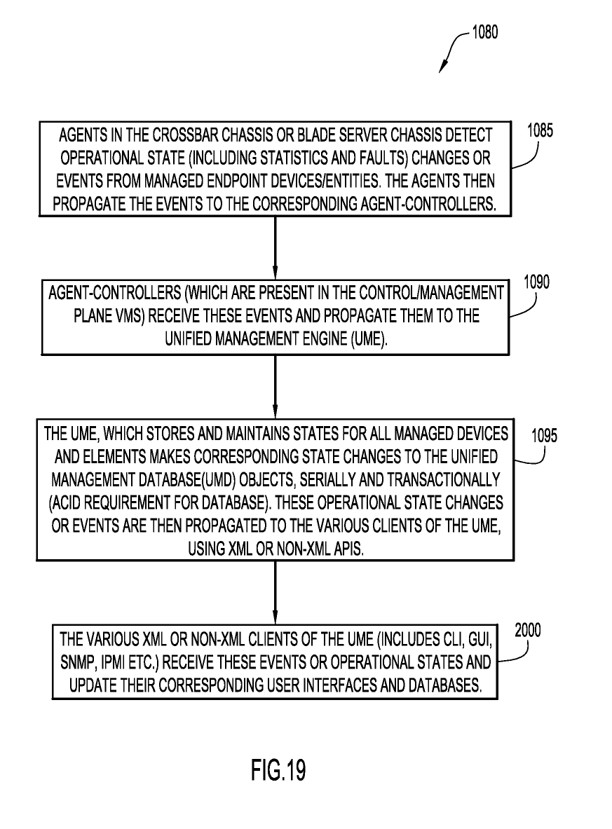

The control protocols 425 run as applications (e.g., Open Shortest Path First (OSPF), Border Gateway Protocol (BGP), Routing Information Protocol (RIP), etc.) on an operating system that updates and maintains its corresponding states (e.g., RIB/MRIB 430). Configuration requests and operational state updates to/from various hardware/software components of the system (as described below with reference to FIGS. 18 and 19) are processed by the unified management software engine 440 and the states/data are updated in the unified management software database 435. The infrastructure controllers 445 are comprised of various infrastructure software controllers (described in FIG. 10), which include, for example, a discovery protocol controller, NIC controller, external virtual-machine controller, BMC/IPMI controller, blade server/chassis controller, port controller, I/O card controller, policy controller, and HA controller.

The software components of crossbar chassis 410 comprise a fabric manager/agent 450 and infrastructure managers/agents 455. The fabric manager/agent 450 initializes, programs, and monitors resources such as, for example, the crossbars. In cases where a crossbar card has a processing subsystem, a special fabric software agent is initialized for coordinating the initialization, programming, and monitoring functionality of crossbars under the control of the fabric manager running in the supervisor cards. The infrastructure managers/agents include, for example, chassis manager/agent, HA manager/agent, port agent, and input/output card agent. The various infrastructure managers/agents 455 in the supervisor card perform, for example, discovery and initialization functionality for all components in a crossbar chassis in FIG. 7 (e.g., input/output card components, crossbar card components, supervisor card component, fan, power supplies and ports). All agents are controlled and coordinated by corresponding agent controllers running in the control and management servers. New software images/packages for crossbar chassis can be downloaded automatically (when default software images are outdated) from the control and management servers.

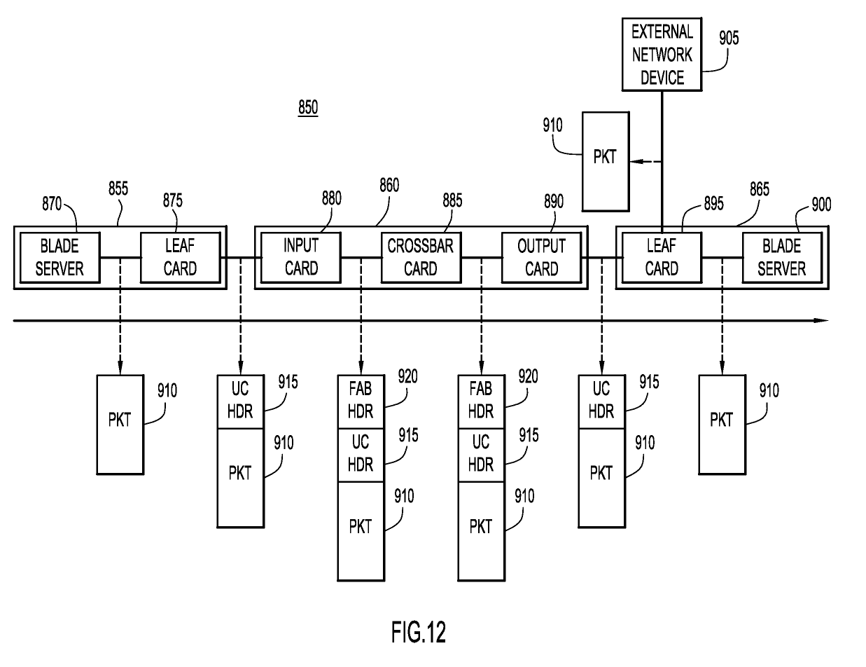

Blade server chassis 415(1) comprises two leaf cards 460(1) and 460(2) and two blade servers 465(1) and 465(2). Blade server chassis 415(2) comprises two leaf cards 460(3) and 460(4) and two blade servers 465(3) and 465(4). The leaf cards 460(1)-460(4) have similar configurations and each include infrastructure agents 470, and Forwarding Information Base (FIB)/Multicast Forwarding Information Base (MFIB) and other forwarding tables 475. These forwarding tables 475 are populated with information received from control and management server 405. In other words, these tables are populated and controlled through centralized control plane protocols provided by server 405. The software components of infrastructure agents 470 include, for example, a chassis agent/manager, a port agent, and forwarding table agents which initialize, program, and monitor various hardware components of a blade server chassis as described in FIG. 6B. The FIB/MFIB and other forwarding tables 475 are programmed in the packet forwarding engine 285 in FIG. 6B via the various forwarding-table agents by the control protocol software running in the control plane server. Packet forwarding engine 285 in FIG. 6B uses these forwarding tables to perform, for example, L2 and L3 forwarding lookups to forward the packets via the crossbar fabric to the destination leaf card(s) as described in FIG. 12. All agents are controlled and coordinated by corresponding agent controllers running in the control/management servers. New software image/package for lead cards can be downloaded automatically (when default software images are outdated) from the control and management servers.

The blade servers 465(1)-465(4) have similar configurations and each include BMC and NIC agents 480. The BMC agent part of the BMC and the NIC software agents run in a BMC processing subsystem 250 of FIG. 6A which includes a service processor and related memories. The NIC agent part of the BMC and NIC agents 480 runs in processing subsystem of NICs in the blade servers, as shown in 245 of FIG. 6A. All agents are controlled and coordinated by corresponding agent controllers running in the control/management servers. New firmware for both the BMC and NIC agents can be downloaded automatically (when default firmware images are outdated) from the control/management servers. The BMC software/firmware agent provides functionality for any pre-OS management access, blade inventory, monitoring/logging attributes (e.g., voltages, currents, temperatures, memory errors), LED guided diagnostics, power management and serial-over-LAN. The BMC software/firmware agent also supports BIOS management, KVM and vMedia, as described in above with reference to FIG. 6A. The NIC software agent initializes, programs, and monitors one or more physical or virtual interfaces 245 in FIG. 6A (Ethernet NIC, Fiber-Channel HBA, etc.). BMC agent also provides functionality to initial pre-OS automatically-configured communication between the BMC agent and the BMC/IPMI controller in control and management servers. It also provides post-OS virtual/physical NICs/adapters support.

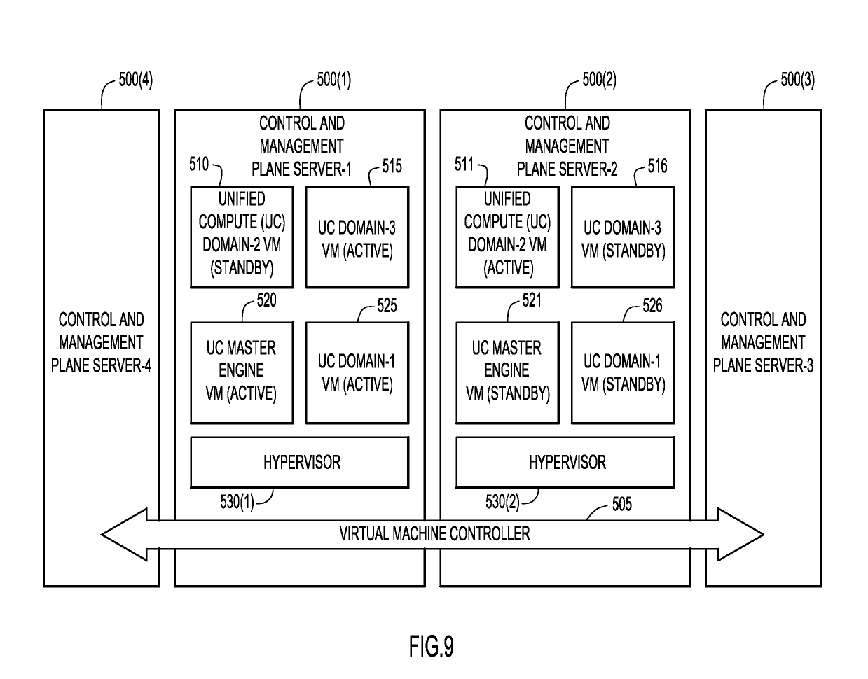

FIG. 9 is a high level block diagram of centralized control and management planes for an enterprise computing system with multiple unified-compute domains and respective virtual machines in accordance with examples presented herein. In this example, control and management servers 500(1) and 500(2) have a respective hypervisors 530(1) and 530(2), along with four active virtual machines (520, 515, 525 and 510) and four standby virtual machines (521, 516, 526 and 511) distributed as shown.

The hypervisors 530(1) and 530(2) create new virtual machines under the direction of a distributed virtual-machine controller software 505 spanning across all the control/management servers. The hypervisor type can be type-2, which runs within a conventional operating system environment. In this example, the centralized control and management plane comprises one active master management/control plane virtual machine, referred to as the unified-compute-master-engine (UCME) virtual machine 520, that controls the other three active unified-compute-domain virtual machines (515, 525 and 510), which run the actual control protocol software for their respective unified-compute-domain. All four Active virtual machines have a corresponding standby virtual machine (521, 516, 526 and 511). The UCME virtual machine 520 is the first virtual machine to boot up and initialize all the shared and pre-assigned resources of the system, in addition to starting at least one unified-compute-domain virtual machine to run all the control protocol software for its domain and which can include all the blade server chassis in the system (if there's only one default unified-compute-domain). When the additional unified-compute-domain virtual machines are created, each starts its own control protocols and manages its private resources (assigned by management plane software running in UCME virtual machine 520) which includes one or more blade server chassis that only belong to its domain.

FIG. 10 is a detailed block diagram of FIG. 8 and UCME virtual machine 520 of FIG. 9. FIG. 10 illustrates various major software components for an enterprise computing system. A primary function of UCME virtual machine 520 is to operate as the master for the whole system. This includes, for example, creating one or more unified-compute-domain virtual machines which actually run control protocol software for each domain and manage all shared (among all domains) and unassigned resources in the system. The UCME virtual machine 520 may not run any L2, L3, and storage protocols. The major software components of the UCME virtual machine 520 comprises: Graphical User Interface (GUI)/Command Line Interface (CLI)/Simple Network Management Protocol (SNMP)/Intelligent Platform Management Interface (IPMI) 660 for various user interfaces; Systems Management Architecture for Server Hardware (SMASH) Command Line Protocol (CLP)/Extensible Markup Language (XML) application programming interface (API) 665 for user interface and XML clients; Policy Manager 670 for policy and profile management; HA Manager 675 for high availability; Unified Management Engine 680 for the logic used in storing and maintaining states all managed devices and elements in a central atomicity, consistency, isolation, durability (ACID) database called Unified Information Database 685; Discovery protocols 695 for discovering all the nodes and end-to-end topology of the system, infrastructure managers for managing various crossbar chassis 565; blade server chassis 570 components; and various agent controllers/gateways for various agents in the systems which include, but are not limited to, NIC agent-controller 700, blade-server-chassis agent-controller 705, Port agent-controller 710, I/O card agent-controller 715, External VM agent-controller 720 for external VM Manager interfaces, BMC/IPMI agent-controller 725 and Fabric card/chassis agent-controller 730. The major software components of a crossbar chassis 410 comprise: a fabric manager/agent 650 for initializing, programming and monitoring all crossbars; I/O card agent 645 for programming virtual-output-queues and UC-header management tables; Port agent 635 for programming and monitoring port features; Chassis agent/manager 630 for managing common chassis functionality such as discovery and registration; HA manager/agent 655 for high-availability; and Infrastructure managers/agents 640 for remaining functionality which includes, but is not limited to, controlling the fan(s), power and temperature. The Blade server chassis 580, which comprises a leaf card 575 and a blade server 580 has major components that include: FIB/MFIB/ACL/QOS/Netflow tables 595 for forwarding lookups and features; forwarding table agents 590 for programming various forwarding tables 595; Port agent 585 for programming and monitoring port features; Chassis agent/manager 605 for managing common chassis functionality which includes, but is not limited to, discovery and registration; NIC agent 615 for programming and monitoring NICs; BMC/IPMI agent for initializing, programming and monitoring all BMC subsystems and coordinating software initialization/download for the main blade server processing subsystem; Pre-boot/Diagnostic agent 625 for performing pre-boot diagnostic by running on the main blade server processing subsystem; and reachability table 610 for choosing the right crossbar chassis ports. All software agents are controlled and coordinated by corresponding agent controllers/gateways running in the control and management servers.

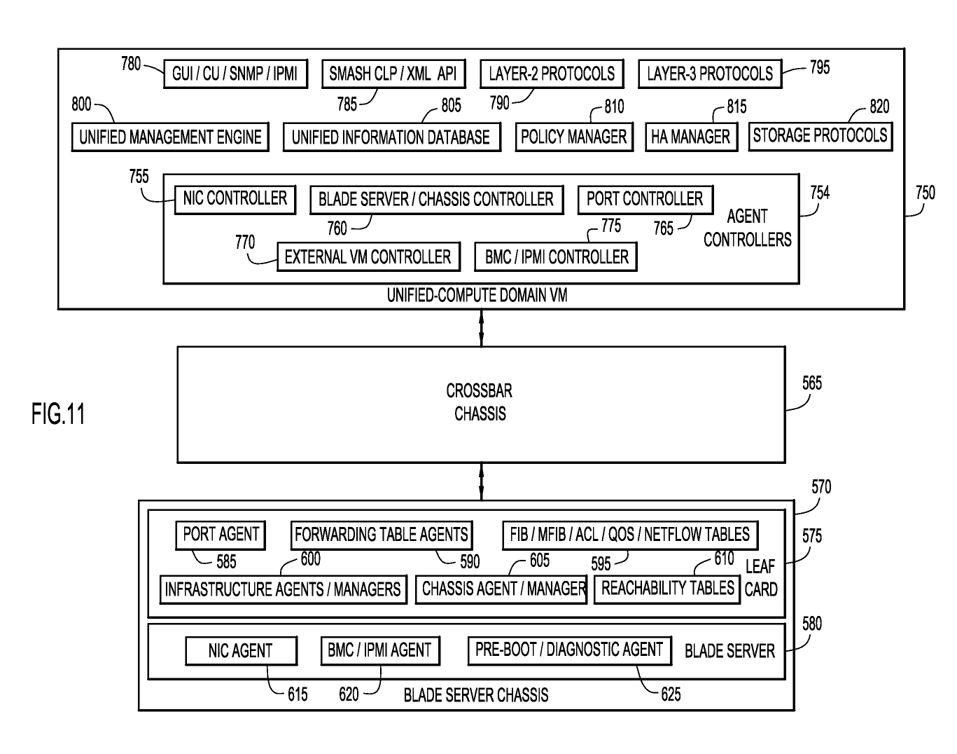

FIG. 11 is a detailed block diagram of FIG. 8 and unified-compute-domain virtual machine 525 of FIG. 9 which includes various major software components for an enterprise computing system. A primary purpose of the unified-compute-domain virtual machine 750 is to function as the Control Plane master for a particular domain including, but not limited to, running all control protocol software for each domain and managing private resources (blade server chassis, etc.) assigned by UCME virtual machine 550 of FIG. 10. All unified-compute-domain virtual machines generally can not exist without a UCME virtual machine. The UC unified-compute-domain virtual machine 750 runs all L2, L3, and storage protocols for a particular domain. The major software components of the UC-Domain VM 750 comprise: GUI/CLI/SNMP/IPMI 780 for various user interfaces; SMASH CLP/XML API 785 for user interface and XML clients; Policy Manager 810 for policy and profile management; HA Manager 815 for high availability; Unified Management Engine 800 for the logic used in storing and maintaining states all managed devices and elements in a central ACID database called Unified Information Database 805; L2 protocols 790 for L2 protocol software; L3 protocols 795 for L3 protocol software; storage protocols 820 for storage protocol software; and various agent controllers/gateways 754 for various agents in the systems which include, but are not limited to, NIC agent-controller 755, blade-server-chassis agent-controller 760, Port agent-controller 765, External virtual machine agent-controller 710 for external virtual machine Manager interfaces and BMC/IPMI agent-controller 775. The crossbar chassis 565 components are the same as crossbar chassis 565 of FIG. 10. The Blade server chassis 580 components are same as the blade server chassis 580 of FIG. 10.

FIG. 12 is a diagram illustrating the flow of a packet from a first blade server to a second blade server in an enterprise computing system 850 implemented as a single logical compute device. In this example, enterprise computing system 850 comprises a first blade server chassis 855, a crossbar chassis 860, and a second blade server chassis 865.

The first blade server chassis 855 comprises a blade server 870 and a leaf card 875. Crossbar chassis 860 comprises an input card 880, a crossbar card 885, and an output card 890. Input card 880 and output card 890 may be the same or different card. The second blade server chassis 865 includes a leaf card 895 and a blade server 400. Also shown in FIG. 12 is an external network device 905.

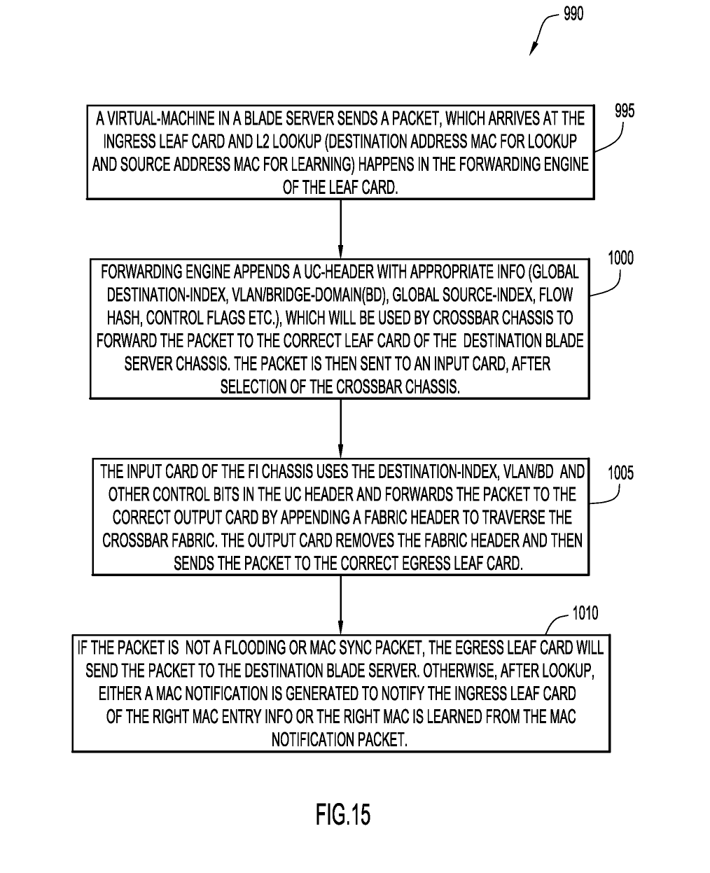

In operation, blade server 870 generates a packet 910 for transmission to blade server 900. The packet 900 is provided to leaf card 875 residing on the same chassis as blade server 870. Leaf card 875 is configured to add a unified compute (UC) header 915 to the packet 910. Further details of the unified compute header 915 are provided below with reference to FIG. 15. In general, the unified compute header 915 is used by a receiving crossbar chassis to forward the packet 910 to the correct leaf card of the correct blade server chassis.

The packet 910 (with unified compute header 915) is forwarded to the input card 880 of crossbar chassis 860, after a layer-2 or layer-3 lookup. The input card 880 is configured to add a fabric (FAB) header 920 to the packet 910 that is used for traversal of the crossbar card 885.

The packet 910 (including unified compute header 915 and fabric header 920) is switched through the crossbar card 885 (based on the fabric header 920) to the output card 890. The output card 890 is configured to remove the fabric header 920 from the packet 910 and forward the packet 910 (including unified compute header 915) to leaf card 895 of blade server chassis 865. The leaf card 895 is configured to remove the unified compute header 915 and forward the original packet 910 to blade server 400. The leaf card 910 may also be configured to forward the original packet 910 to external network device 905.

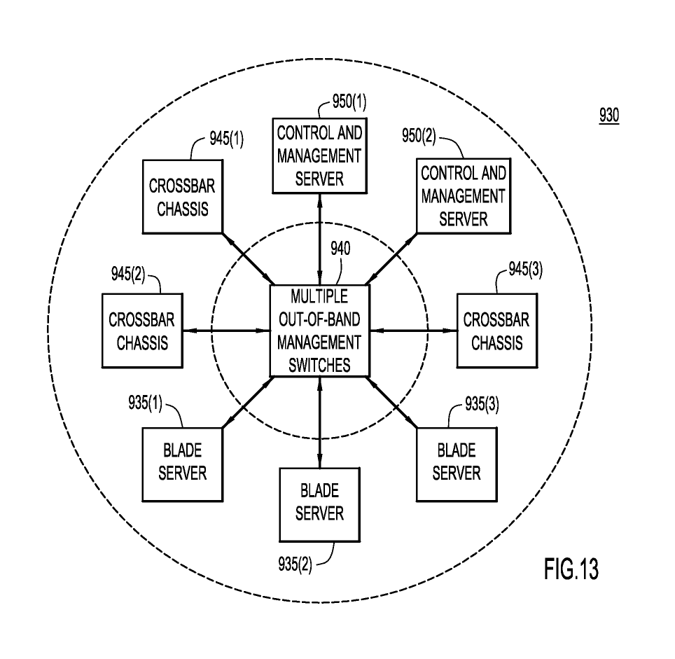

FIG. 13 is block diagram of another enterprise computing system 930 in accordance with examples presented herein. As shown, connected to the out-of-band management switches 940 are three crossbar chassis 945(1), 945(2), and 945(3), three blade server chassis 935(1)-935(3) and two control and management servers 950(1) and 950(2). The internal control packets from all the crossbar chassis, blade server chassis and control and management servers pass through the multiple Ethernet-out-of-band management switches 940. This provides a separate physical path for internal control packets as compared to FIG. 3 where the internal control packet uses the same physical path which is also used by data packets. As such, FIG. 13 increases the reliability and redundancy of control packet between the various nodes. The Ethernet-out-of-band management switches 940 are all independent switches which initialize and function independently without any control from the control and management servers of the system. The Ethernet-out-of-band management switches 940 function similar to an independent internal Ethernet-out-of-band switch that is used in existing supervisor cards of a single device switch or router.

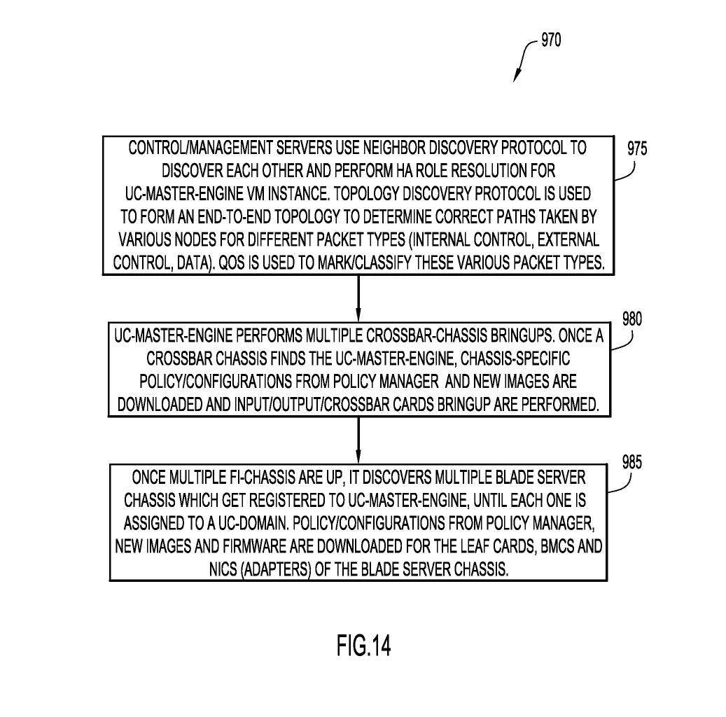

FIG. 14 is a flowchart of a method 970 in accordance with examples presented herein. Method 970 begins at 975 where control/management servers use the Neighbor Discovery Protocol (NDP) to discover one another and perform HA Role resolution for a UCME virtual machine instance. More specifically during boot up, the High Availability manager in two UCME virtual machine instances perform a handshake/negotiation to determine which will become an active UCME and which will become a standby UCME. The standby takes over whenever the active fails due to various reasons.

A topology discovery protocol is also used to form an end-to-end topology to determine correct paths taken by various nodes for different packet types (e.g., internal control, external control, data). QoS is used to mark/classify these various packet types.

At 980, the UCME performs multiple crossbar-chassis “bringups” to bring the crossbar chassis online. During crossbar-chassis bring-up, the major software components (e.g., fabric manager/agent, chassis manager/agent, HA manager/agent and various infrastructure managers/agents in the active supervisor card) perform discovery and initialization functionality for all components in a crossbar chassis. The UCME also initializes the various infrastructure managers/agents described above.

Once a crossbar chassis finds the UCME, chassis-specific policy/configurations from a policy manager and new images are downloaded (when default software images are outdated), and Input/Output and crossbar cards bringups are performed. During an input/output card bring-up, various software agents which initialize, program, and monitor resources (e.g., virtual-output-queues and unified-compute header lookup tables) are started. For a crossbar card bring-up, the fabric manager running in the supervisor initializes, programs, and monitors various resources, such as the crossbars. In cases where a crossbar card has a processing subsystem, various software agents are initialized for coordinating the initialization, programming and monitoring functionality of various resources such as the crossbars and sensors, under the control of software running in the supervisor cards.

At 985, once the multiple FI-chassis are up, the UCME in the control and management server (via the crossbar or fabric-interconnect (FI)-chassis) discovers multiple blades server chassis that get registered and are assigned to a unified-compute-domain. Policy/Configurations are received from a policy manager, new images and firmware are downloaded (when default software and firmware images are outdated) for the leaf cards, BMCs and NICs (adapters) of the blade server chassis.

FIG. 15 is a flowchart of a method 990 in accordance with examples presented herein. Method 990 begins at 995 where a virtual machine in a blade server sends a packet, which arrives at an ingress leaf card of a blade server chassis. An L2 lookup (Destination Media Access Control (MAC) address for lookup and Source Address MAC for Learning) occurs in the forwarding engine of the leaf card, as part a single distributed data plane.

At 1000, the forwarding engine appends a unified-compute header with appropriate info (e.g., Global Destination-Index, Virtual Local Area Network (VLAN)/Bridge-Domain (BD), Global Source-Index, Flow Hash, Control flags, etc.), which will be used by a receiving crossbar chassis to forward the packet to the leaf card of a destination blade server chassis (i.e., the blade server chassis on which a destination blade server is disposed). The packet is then sent by the forwarding engine to an input card after selection of the correct crossbar chassis port(s).

At 1005, the input card of the selected crossbar chassis uses the Destination-Index, VLAN/BD and other control bits in the UC header to forward the packet to the correct output card by appending a fabric header to traverse the crossbar fabric. The output card removes the fabric header and then sends the packet to the leaf card of the destination blade server chassis.

At 1010, a determination is made as to whether the packet is a flooding or MAC Sync Packet. If the packet is not a Flooding or MAC Sync Packet, the egress leaf card will send the packet to the destination blade server or external networking device. Otherwise, after a lookup, either a MAC Notification is generated to notify the ingress leaf card of the correct MAC entry information or the MAC is learned from the MAC Notification Packet.

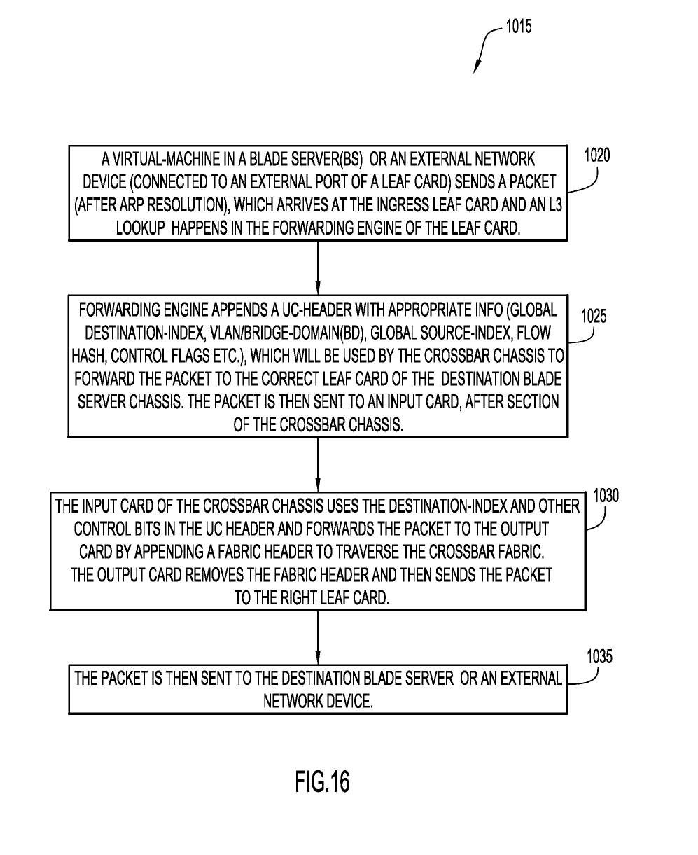

FIG. 16 is a flowchart of a method 1015 in accordance with examples presented herein. Method 1015 begins at 1020 where a virtual machine in a blade server or an external network device (i.e., a device connected to an external port of a leaf card) sends a packet (after Address Resolution Protocol (ARP) resolution), which arrives at the ingress leaf card of a blade server chassis. Subsequently, a L3 lookup (assuming ingress lookup only model) occurs in the forwarding engine of the leaf card, as part of a single distributed data plane.

At 1025, the forwarding engine appends a unified-compute header with appropriate info (e.g., Global Destination-Index, Global Source-Index, Hash-Value, Control flags, etc.) which will be used by a crossbar chassis to forward the packet to the correct leaf card of the destination blade server chassis. The packet is then sent to an input card after selection of the correct crossbar chassis.

At 1030, the input card of the crossbar chassis uses the Destination-Index and other control bits in the unified-compute Header and forwards the packet to the output card by appending a fabric header to traverse the crossbar fabric. The output card removes the fabric header and then sends the packet to the leaf card of the destination blade server chassis. At 1035, the packet is then sent to the destination blade server or an external network device.

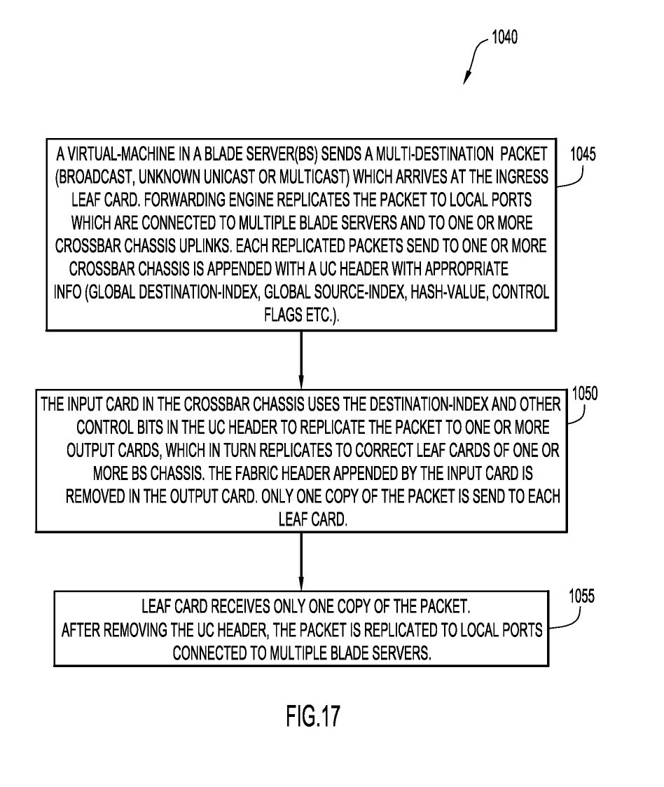

FIG. 17 is a flowchart of a method 1040 in accordance with examples presented herein. Method 1040 begins at 1045 where a virtual machine in a blade server sends a Multi-Destination packet (e.g., Broadcast, Unknown Unicast or Multicast) which arrives at the leaf card on the same blade server chassis. The forwarding engine replicates the packet to local ports which are connected to multiple blade servers (may include external networking devices) and to one or more crossbar chassis uplink ports. Each replicated packets sent to the one or more crossbar chassis is appended with a unified-compute header with appropriate information (e.g., Global Destination-Index, Global Source-Index, Hash-Value, Control flags, etc.). At 1050, the input card in a receiving crossbar chassis uses the Destination-Index and other control bits in the unified-compute header to replicate the packet to one or more output cards, which in turn replicate the packet to correct leaf cards of one or more blade server chassis. Only one copy of the packet is sent to each leaf card. At 1055, after removal the unified-compute header at a leaf card, the packet is replicated to local ports which are connected to multiple blade servers (may include external networking devices).

FIG. 18 is a flowchart of a method 1060 in accordance with examples presented herein. Method 1060 begins at 1065 where, in the control/management virtual machines, configuration Requests or Policy/Service Profile for Physical/Logical components of LAN, SAN, Server from CLI, GUI, SNMP, IPMI and various XML-API clients are sent to a Unified Management Engine (UME) using XML or non-XML application programming interfaces (APIs).

At 1070, the UME, which stores and maintains states for all managed devices and elements, validates the configuration request. The UME also makes corresponding state changes on the Unified Management Database (UMD) objects, serially and transactionally (ACID requirement for database). The state changes are then propagated to the correct agents of crossbar chassis or blade server chassis through the appropriate agent-controller.

At 1075, agent-controllers (used by the UME) compare the administrative and operational state of the managed objects and endpoint devices/entities. The agent-controllers then propagate the configuration changes to the endpoint devices/entities, using the corresponding agents that are running on either the crossbar chassis or blade server chassis.

FIG. 19 is a flowchart of a method 1080 in accordance with examples presented herein. Method 1080 begins at 1085 where agents in the crossbar chassis or blade server chassis detect operational state (including statistics and faults) changes or events from managed endpoint devices/entities. The agents then propagate the events to the corresponding agent-Controllers.

At 1090, the agent-controllers (which are present in the Control/Management virtual machines) receive these events and propagate them to the UME. At 1095, the UME, which stores and maintains states for all managed devices and elements, makes corresponding state changes to the UMD objects, serially and transactionally (ACID requirement for Database). These operational state changes or events are then propagated to the various clients of the UME, using XML or non-XML APIs. At 2000, the various XML or non-XML clients of the UME (includes CLI, GUI, SNMP, IPMI, etc.) receive these events or operational states and update their corresponding user interfaces and databases.

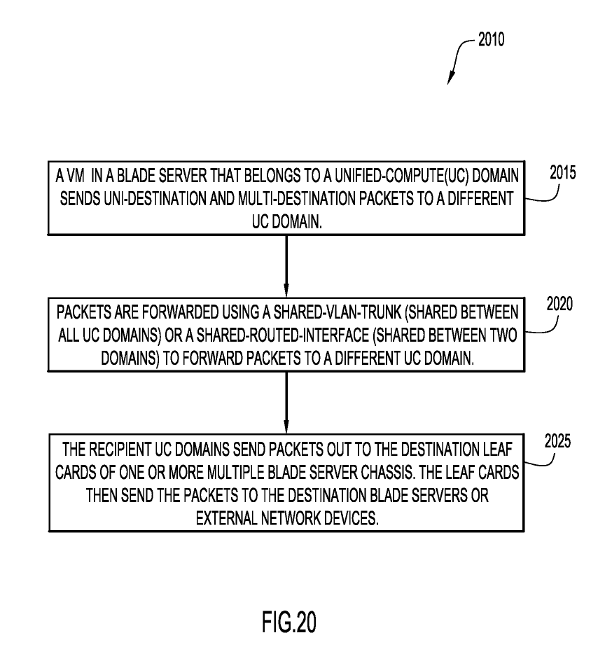

FIG. 20 is a flowchart of a method 2010 in accordance with examples presented herein. Method 2010 begins at 2015 where a virtual machine in a blade server that belongs to a unified-compute-domain sends Uni-Destination and Multi-Destination packets to a different unified-compute-domain. At 2020, the packets are forwarded to the different unified-compute-domain using a Shared-VLAN-Trunk (shared between all unified-compute-domain) or a Shared-Routed-Interface (Shared between two unified-compute-domain). At 2025, the recipient unified-compute-domains send packets out to the destination leaf cards of one or more multiple blade server chassis. The leaf cards then send the packets to the destination blade servers or external network devices.

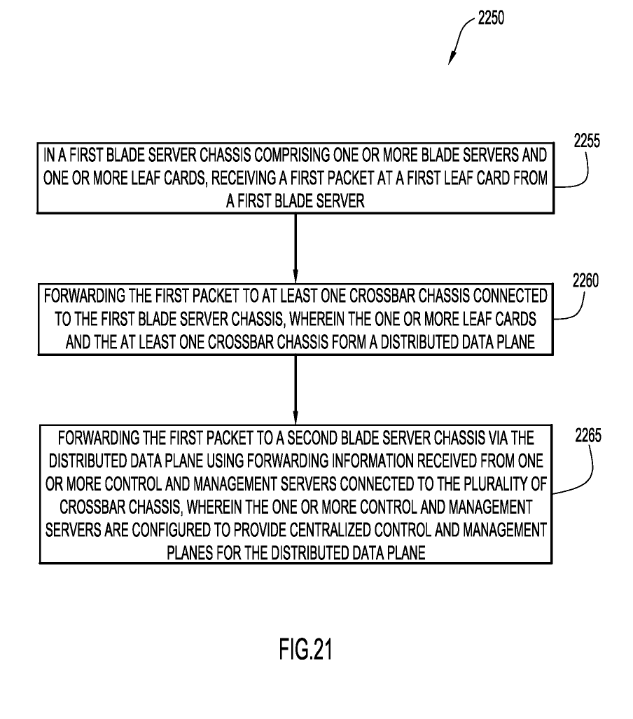

FIG. 21 is a high-level flowchart of a method 2250 in accordance with examples presented herein. Method 2250 begins at 2255 where, in a first blade server chassis comprising one or more blade servers and one or more leaf cards, a first packet is received at a first leaf card from a first blade server. At 2260, the first packet is forwarded to at least one crossbar chassis connected to the first blade server chassis. The one or more leaf cards and the at least one crossbar chassis form a distributed data plane. At 2265, the first packet is forwarded to a second blade server chassis via the distributed data plane using forwarding information received from one or more control and management servers connected to the plurality of crossbar chassis. The one or more control and management servers are configured to provide centralized control and management planes for the distributed data plane.

The above description is intended by way of example only.

What is claimed is:

1. A system comprising:
a plurality of blade server chassis each comprising one or more leaf cards, wherein the leaf cards are elements of a distributed data plane interconnecting the blade server chassis;
at least one crossbar chassis connected to the plurality of blade server chassis, wherein the crossbar chassis is configured to provide a crossbar switching functionality for the distributed data plane; and
one or more control and management servers connected to the crossbar chassis configured to provide centralized control and management planes for the distributed data plane.

2. The system of claim 1, wherein only the leaf cards are configured to perform end-to-end layer-2 (L2) and layer-3 (L3) forwarding lookups for packets transmitted on the distributed data plane.

3. The system of claim 1, wherein the control and management servers are configured to execute control protocols to distribute forwarding information to the crossbar chassis and the leaf cards.

4. The system of claim 3, wherein the control protocols include L2, L3, and storage protocols.

5. The system of claim 1, wherein the control and management servers are configured to perform centralized data management for physical and software entities of the plurality of blade server chassis and the crossbar chassis.

6. The system of claim 1, wherein a first leaf card is configured to:
receive a first packet from a blade server,
after forwarding lookup, append a unified-compute header to the first packet for transmission on the distributed data plane, and
forward the first packet to the at least one crossbar chassis.

7. The system of claim 6, wherein the at least one crossbar chassis is configured to append a fabric header to the first packet.

8. The system of claim 1, wherein the plurality of blade server chassis are arranged into a plurality of virtual unified compute domains that each comprise at least one blade server chassis.

9. The system of claim 8, wherein the plurality of virtual unified compute domains are configured to forward packets between one another using an internal virtual local area network (VLAN) trunk that is shared between all unified compute domains.

10. The system of claim 8, wherein the plurality of virtual unified compute domains are configured to forward packets between one another using an internal routed interface that is shared between any two unified compute domains.

11. The system of claim 1, wherein the at least one crossbar chassis comprises a plurality of crossbar chassis arranged as a multi-stage crossbar fabric, wherein a plurality of first-stage crossbar chassis and last-stage crossbar chassis are connected via a plurality of middle-stage crossbar chassis as part of the distributed data plane.

12. The system of claim 11, wherein one or more leaf cards of a first set of blade server chassis are connected to the first-stage crossbar chassis and one or more leaf cards of a second set of blade server chassis are connected to the last-stage crossbar chassis.

13. The system of claim 1, further comprising:
a plurality of independent Ethernet-out-of-band switches that are configured to forward internal control packets between the blade server chassis, the crossbar chassis, and the control and management servers.

14. The system of claim 1, wherein the at least one crossbar chassis comprises a plurality of input/output cards configured to be connected to one or more external network devices, and wherein the input/output cards are configured to perform end-to-end L2 and L3 forwarding lookups as part of the distributed data plane.

15. A method comprising:
in a first blade server chassis comprising one or more blade servers and one or more leaf cards, receiving a first packet at a first leaf card from a first blade server;
forwarding the first packet to at least one crossbar chassis connected to the first blade server chassis, wherein the one or more leaf cards and the at least one crossbar chassis form a distributed data plane; and
forwarding the first packet to a second blade server chassis via the distributed data plane using forwarding information received from one or more control and management servers connected to the plurality of crossbar chassis, wherein the one or more control and management servers are configured to provide centralized control and management planes for the distributed data plane.

16. The method of claim 15, further comprising:
performing end-to-end layer-2 (L2) and layer-3 (L3) forwarding lookups only at the first leaf card for transmission of the first packet on the distributed data plane.

17. The method of claim 15, wherein the control and management servers are configured to execute control protocols, and wherein the method further comprises:
distributing forwarding information to the crossbar chassis and the leaf cards using the control protocols.

18. The method of claim 17, further comprising:
performing centralized data management for physical and software entities of the crossbar chassis and the first and second blade server chassis.

19. The method of claim 15, further comprising:
at the first leaf card, after forwarding lookup, appending a unified-compute header to the first packet for transmission on the distributed data plane prior to forwarding the first packet to the least one crossbar chassis.

20. The method of claim 19, further comprising:
at the at least one crossbar chassis, appending a fabric header to the first packet.

21. The method of claim 15, wherein the first and second of blade server chassis are arranged into a plurality of virtual unified compute domains that each comprise at least one blade server chassis, and further comprising:
at the first leaf card, forwarding the first packet between the plurality of virtual unified compute domains using an internal virtual local area network (VLAN) trunk that is shared between all unified compute domains.

22. The method of claim 15, wherein the first and second of blade server chassis are arranged into a plurality of virtual unified compute domains that each comprise at least one blade server chassis, and further comprising:
at the first leaf card, forwarding the first packet between the plurality of virtual unified compute domains using an internal routed interface that is shared between any two unified compute domains.

23. The method of claim 15, further comprising:
forwarding internal control packets between the first and second blade servers, at least one crossbar chassis, and control and management servers via a plurality of independent Ethernet-out-of-band switches.

24. An apparatus comprising:
a supervisor card;
a plurality of crossbar cards each comprising crossbar switching hardware; and
a plurality of input/output cards each comprising a plurality of network ports and a fabric interface processor,
wherein a first input/output card is configured to receive a first packet from a first blade server chassis comprising one or more blade servers and one or more leaf cards and forward the first packet to a second input/output card via one or more of the crossbar cards using information received from one or more control and management servers configured to provide centralized control and management planes for the apparatus.

25. The apparatus of claim 24, wherein the first packet is received at the first input/output card with a unified-compute header, and wherein the fabric interface processor is configured to use the unified compute header to forward the first packet to the second input/output card.

26. The apparatus of claim 24, wherein the fabric interface processor is configured to append a fabric header to the first packet prior to forwarding the packet to the second input/output card.

27. The apparatus of claim 26, wherein the one or more of the crossbar cards are configured to use the fabric header to forward the first packet to the second input/output card.
